(19) United States
(12) Patent Application Publication
(10) Pub. No.: US 2020/0023491 A1
(43) Pub. Date: Jan. 23, 2020

(54) METHODS AND SYSTEMS FOR RECONDITIONING REMOTE CONTROLS

(71) Applicant: fm marketing gmbh, Neumarkt am Wallersee (AT)

(72) Inventor: Ferdinand MAIER, Neumarkt am Wallersee (AT)

(73) Assignee: fm marketing gmbh, Neumarkt am Wallersee (AT)

(21) Appl. No.: 16/498,261

(22) PCT Filed: Apr. 3, 2018
(86) PCT No.: PCT/EP2018/058498

§ 371 Date: Sep. 26, 2019

(30) Foreign Application Priority Data
Mar. 31, 2017 (DE) 10 2017 107 030.3

(51) Int. Cl. B24C 1/00; B24C 3/32; B24C 7/00; H01H 9/02

(52) U.S. Cl. CPC B24C 1/003; B24C 3/322; H01H 2231/032; H01H 9/0235; B24C 7/0046

(57) ABSTRACT

The invention relates to a method for reconditioning a remote control (1) with a housing consisting of an upper shell (2) and a lower shell (3), and a printed circuit board (21) carrying raised keys (5) for triggering control signals by pressure, the raised keys (5) penetrating the upper shell (2), said method comprising: removing (52) the upper shell (2) and the lower shell (3); blasting (55) at least one of the raised keys (5) on the printed circuit board (21) with an antibacterial abrasive; and inserting (58) the printed circuit board (21) with the raised keys (5) supported thereon between a new upper shell (2) and a new lower shell (3).

The present invention relates to a remote control.

A remote control is known, for example, from DE 10 2015 120 174. The remote control comprises a housing consisting of an upper shell and a lower shell as well as a printed circuit board carrying raised buttons for triggering control signals by pressure. The raised buttons penetrate the upper shell so that the user may operate the raised buttons on the upper shell.

According to one aspect of the invention, a method for reconditioning a remote control with a housing consisting of an upper shell and a lower shell, and a printed circuit board carrying raised buttons for triggering control signals by pressure, the raised buttons penetrating the upper shell, said method comprising the following steps: removing the upper shell and the lower shell; blasting at least one of the raised buttons on the printed circuit board with an antibacterial abrasive; and inserting the printed circuit board with the raised buttons supported thereon between a new upper shell and a new lower shell.

The cited method is based on the consideration that it is very cost-intensive to produce remote controls, particularly in the premium range, which is why the recycling of used remote controls offers economic advantages. A further advantage is that it is less costly to produce the housing shells than the remaining components, and that they can therefore be replaced very easily due to their wear marks which are usually clearly visible. This further increases the cost-benefit effect of recycling.

However, the raised buttons are usually made of a material, off which the user's finger slips less easily, so that they offer good grip when operating the remote control. However, bacteria and other pathogens also have good grip on this material and, in the worst case scenario, can be transferred to a new owner after recycling of the remote control. The raised buttons, however, are part of the more cost-intensive components in the remote control, which is why it is recommended to disinfect the raised buttons with an abrasive when reconditioning the remote control with the cited method.

The use of an abrasive makes it possible to carry out the disinfection very precisely, and to avoid, for example, that components such as the electronics of the remote control are affected and damaged by the abrasive. In addition, the reconditioning process using the abrasive may be at least partially automated.

In a further embodiment of the stated method, dry ice is used as the abrasive. Dry ice is not electroconductive, is chemically inert, non-toxic and non-flammable. Unlike other abrasives, dry ice passes directly from the solid to the gaseous state at ambient pressure without liquefaction—it sublimates. The dry ice particles hitting the raised buttons to be disinfected undercool and embrittle the surface of the raised buttons locally. The dry ice particles coming next thus enter the brittle cracks in the raised button and sublimate abruptly after they hit the surface of the raised button. The dry ice becomes gaseous and increases its volume so much that, in addition to disinfection, it also blows dirt off the surface of the raised button. In this way, not only disinfection but also cleaning of the surface of the raised button is achieved at the same time.

The disinfection with dry ice is minimally abrasive and non-corrosive. The raised buttons to be disinfected will therefore be damaged only slightly—if at all. In addition, no disinfectant remains after the disinfection, but evaporates, so there are no costs incurred for the disposal of disinfectants.

In a particular further embodiment of the stated method, the dry ice is carbon dioxide. Such an abrasive is light, cost-saving and can be provided in sufficient amounts, so that the reconditioning process of the remote control can be realized in an economically effective manner.

In a particularly preferred embodiment of the stated method, the carbon dioxide in the form of dry ice has a temperature in the range of its sublimation temperature, i.e. between −80° C. and −75° C. In this way it is ensured that the carbon dioxide in the form of dry ice sublimates when it hits the surface to be disinfected, and achieves its cleaning effect in addition to the disinfecting effect.

In a further embodiment of the stated method, the raised buttons are exposed to the abrasive from at least two different directions for blasting. In this way, spatial structures on the raised buttons are also disinfected from several sides.

In a further embodiment of the stated method, the time of exposure is between 1 s and 10 s, preferably between 5 s and 7 s from each direction. Such exposure times ensure that the abrasive has an adequate disinfecting effect.

In another embodiment, the abrasive is suctioned off after blasting the raised buttons, so that contaminations ablated from the surface of the raised buttons can also be removed by the abrasive.

In an additional embodiment, the stated method comprises the step of carrying out a function test before removing the upper shell and the lower shell. The function test ensures that no remote controls are reconditioned which afterwards can no longer be used due to technical faults.

According to a further aspect of the stated invention, a remote control is reconditioned by one of the stated methods.

In accordance with a further aspect of the invention, a device being used for reconditioning a remote control with one of the stated methods comprises a loading station for inserting the printed circuit board with the raised buttons supported thereon, a blasting station adjoining the loading station for blasting the raised buttons on the printed circuit board with an antibacterial abrasive, and an unloading station adjoining the blasting station for removing the blasted printed circuit board.

The above-described properties, features and advantages of this invention, as well as the manner in which they are achieved, will become clearer in connection with the following description of the embodiments, which are described in more detail in connection with the drawings, in which:

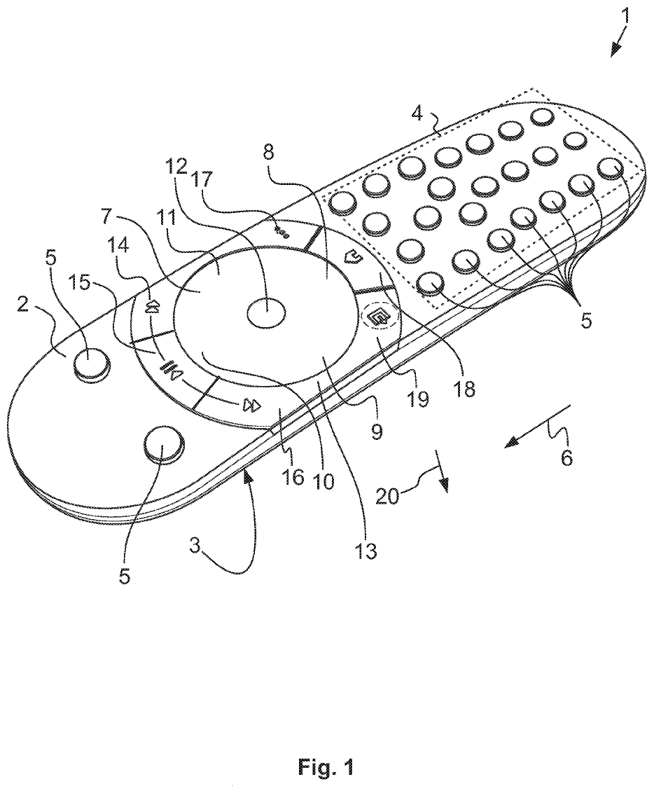

FIG. 1 is a perspective view of a remote control;

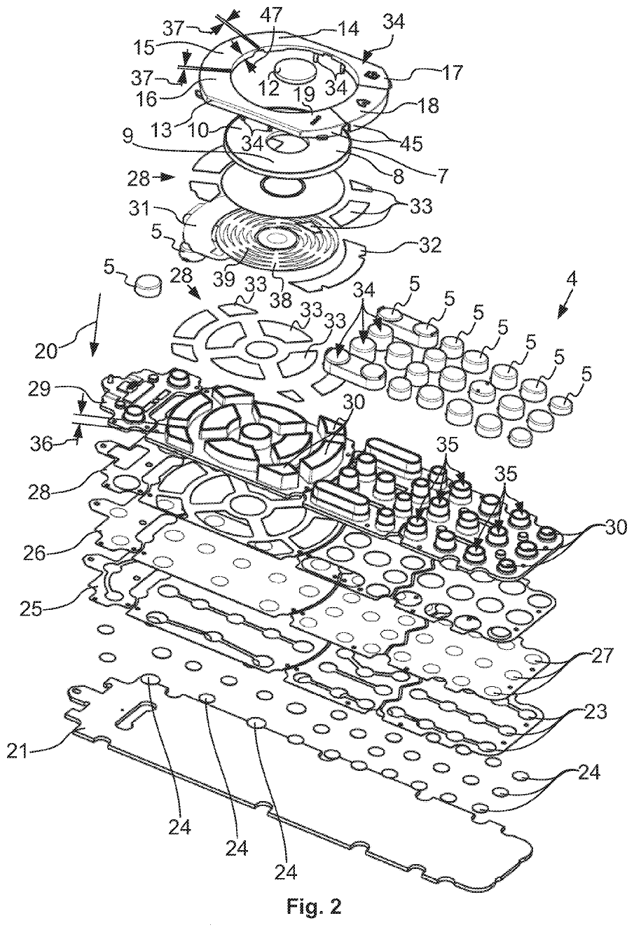

FIG. 2 shows a perspective exploded view of an inner part of the remote control from FIG. 1,

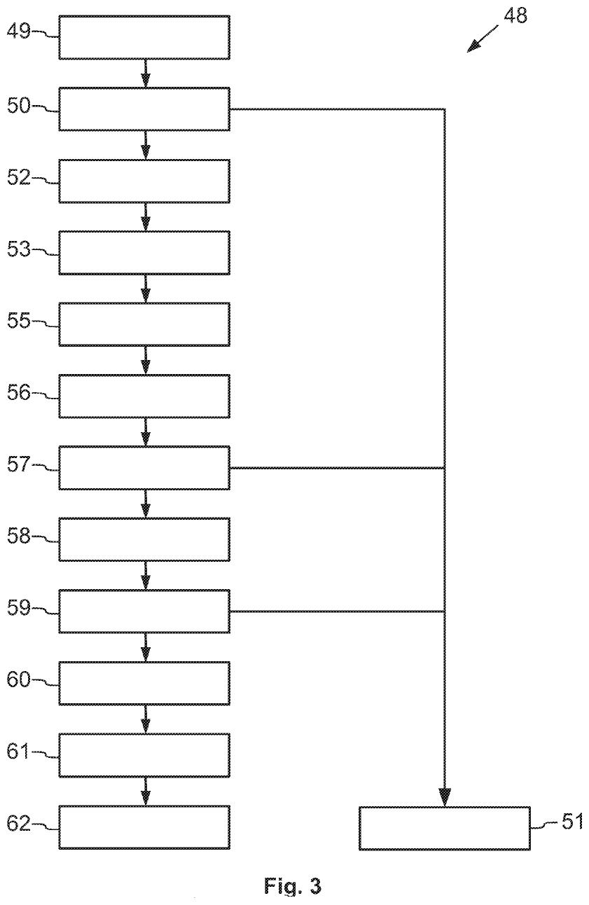

FIG. 3 is a process diagram of a method for reconditioning the remote control of FIGS. 1 and 2 with the device of FIG. 3,

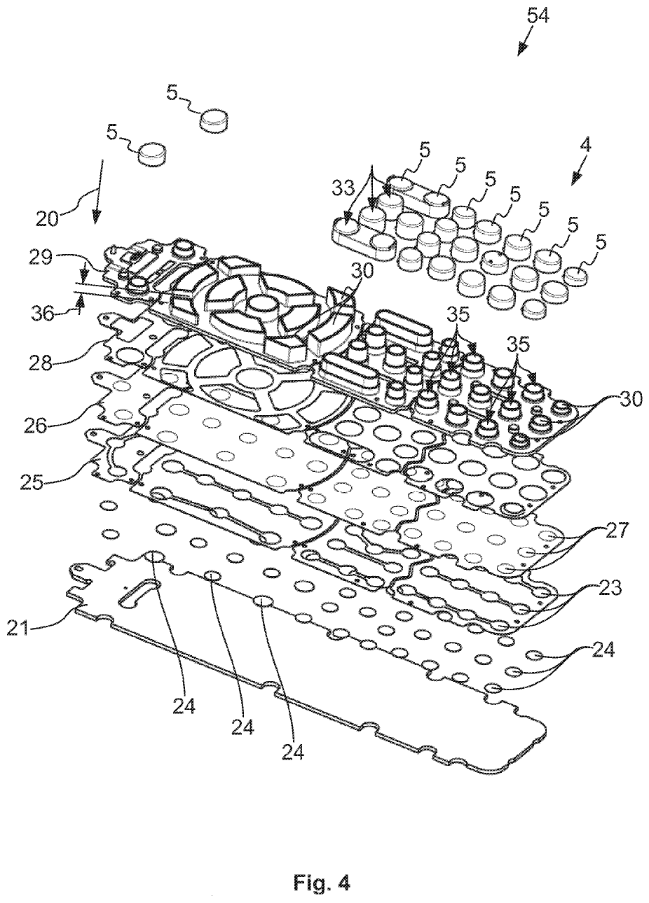

FIG. 4 is the inner part of the remote control of FIG. 2 which is prepared for disinfection, and

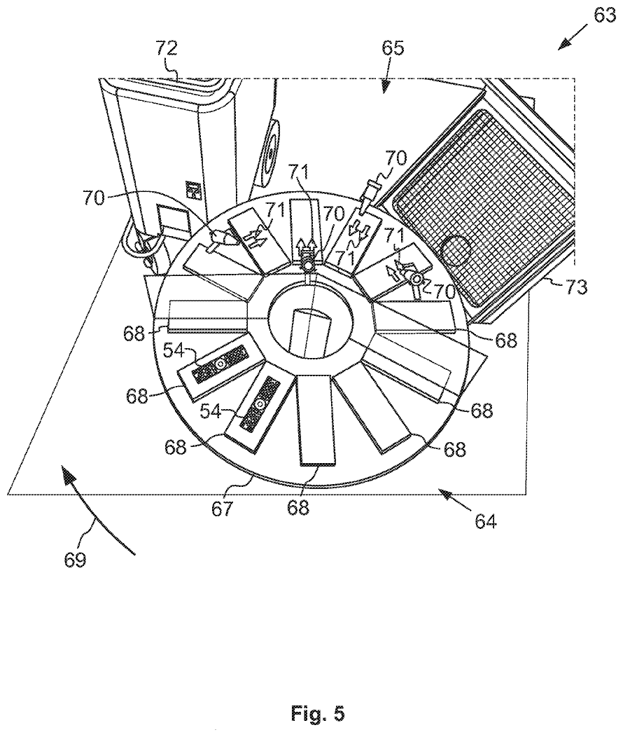

FIG. 5 shows a device for blasting raised buttons on a printed circuit board of the remote control of FIGS. 1 and 2.

In the drawings, the same technical elements are provided with the same reference signs, and are only described once. The drawings are purely schematic, and, in particular, do not reflect the actual geometric proportions.

Reference is made to FIG. 1 showing a perspective view of a remote-control system 1.

The remote control 1 comprises a housing consisting of an upper shell 2 and a lower shell 3, as well as a keypad 4 with a number of button elements 5. For the sake of clarity, not all of the button elements 5 in the keypad 4 are provided with reference signs in the drawings.

A control ring 7 is arranged in a viewing direction 6 above the keypad 4 comprising a first button element 8, a second button element 9, a third button element 10 and a fourth button element 11. The four button elements 8 to 11 are designed for moving a control element on an electronic device that is not shown in any more detail, which can be embodied, for example, as a multimedia device, and the button elements are therefore arranged in the four possible directions of movement around the circumference of a confirmation button 12 at 90° intervals. The control ring 7 having the four button elements 8 to 11 is designed as circular disc in this case.

The control ring 7 is entirely surrounded by a button ring 13. The button elements of the button ring 13 differ in their shape from the other button elements 5 on the remote control 1, as, for example, in the keypad 4. A first button element 14 of the button ring 13, a second button element 15 of the button ring 13, and a third button element 16 of the button ring 13 are arranged around the circumference of the control ring 7 above this control ring 7 as viewed in the viewing direction 6, while a fourth button element 17 of the button ring 13, a fifth button element 18 of the button ring 13, and a sixth button element 19 of the button ring 13 are arranged around the circumference of the control ring 7 below this control ring 7 as viewed in the viewing direction 6.

Finally, in the viewing direction 6 above the first to third button elements 14 to 16 of the button ring 13, two further button elements 5 are arranged which are embodied in the same manner as the button elements 5 in the button field 4.

The remote control 1 is to be used to control the operation of the electronic device which is not shown in any further detail, such as a set-top box. To this end, a user uses the buttons on the upper shell 2 of the remote control 1 to enter control commands into the remote control 1 in the form of data, which is then transmitted to the electronic device to be controlled via a transmitter not shown in any further detail.

In doing so, the user normally holds the remote control 1 with the lower shell 3 in their fingers, while using their thumb to operate the individual button elements on the upper shell 2 in order to input data. In order to input data, the user can, on the one hand, press any of the button elements on the upper shell 2 in a pressure direction 20 into an interior space of the housing delimited by the upper shell 2 and the lower shell 3. On the other hand, the user is also able to input data by touching the control ring 7 or the button ring 13 without exerting any pressure, and by navigating back and forth with their thumb on the corresponding button elements, which is referred to below as swiping.

The input of data via pressure is explained in more detail below with the aid of FIG. 2, which shows an exploded view of the inner components of the remote control 1.

The remote control 1 comprises in its interior a printed circuit board 21, on which galvanically isolated switching contacts that are not depicted in any further detail are formed, which can be short-circuited by means of electrically conductive contact domes 24. For the sake of clarity, not all these contact domes 24 are given reference signs in FIG. 2.

The contact domes 24 are positioned on the printed circuit board 21 in a manner known per se with their edge region on a switching contact. When the button elements 5, 8 to 11 and 14 to 19 on the remote control 1 are pressed in the pressure direction 20, the contact domes 24 are then pressed down in their centres against a further switching contact on the printed circuit board 21. The switching contacts that are short-circuited in this manner now conduct an electrical current, which can then be evaluated in order to determine which of the button elements 5, 8 to 11 and 14 to 19 the user has pressed on the remote control 1. The switching contacts therefore serve, along with the contact domes 24, as data read-in devices with which the data input of the user can be read into an electric circuit on the printed circuit board 21.

In order to mechanically connect the contact domes 24 to the button elements 5, 8 to 12 and 14 to 19, a spacer film 25 with openings 23 is placed on the printed circuit board 21. For the sake of clarity, not all these openings 23 are given their own reference signs in FIG. 2. A retaining film 26 that holds the contact domes 24 in place is positioned on the spacer film 25. The holding points 27 on the retaining film 26 are marked with small circles, not all of which are given a reference sign in FIG. 2 for the sake of clarity. As viewed in the pressure direction 20, the holding points 27 are positioned precisely over the openings 23 in the spacer film 25. When the retaining film 26 is placed on the spacer film 25, the individual contact domes 24 are thus guided through the openings 23 and can be pressed down in order to short-circuit the switching contacts.

An adhesive film 28 is placed on the spacer film 25, by means of which a rubber mat 29 is held on the spacer film 25. A number of pressure take-up elements 30 are formed on this rubber mat 29 which, on the one hand, absorb a pressure exerted on the individual button elements 5, 8 to 12 and 14 to 19 in the pressure direction 20 and thus press down the contact domes 24 in the manner described above. On the other hand, the pressure take-up elements 30 reset the button elements 5, 8 to 12 and 14 to 19 to a starting position counter to the pressure direction 20 when the pressure on the button elements 5, 8 to 12 and 14 to 19 is removed. All button elements 5 outside the button ring 13 are held directly and in a form-fitting manner on the pressure take-up elements 30 on the rubber mat 29.

In contrast, the button elements 14 to 19 of the button ring 13 and the button elements 8 to 12 inside the button ring 13 are held on the pressure take-up elements 30 via a first flexible film 31 and a second flexible film 32. In order to enable the above-mentioned alternative input of data via swiping, the first flexible film 31 is embodied here as a flexible printed circuit board, and is therefore referred to below as flexible printed circuit board 31. The technical details of the printed circuit board will be examined later.

The flexible printed circuit board 31 and the second flexible film 32 are adhesively bonded onto the pressure take-up elements 30 via a further adhesive film 28 composed of a number of adhesive elements 33 that are not contiguous with one another. For the sake of clarity, not all these adhesive elements 33 are given their own reference signs in FIG. 2.

The button elements 14 to 19 of the button ring 13 and the button elements 8 to 12 inside the button ring 13 are adhesively bonded via a further adhesive film 28 with adhesive elements 33 on the side of the flexible printed circuit board 31 and of the second flexible film 32 that is opposite the pressure take-up elements 30, where once again, for the sake of clarity, not all the adhesive elements are given their own reference signs.

To input data via pressure, the user presses one of the button elements 5, 8 to 12 or 14 to 19 in the pressure direction 20 as viewed on the top side, hereinafter referred to as pressure take-up side 34 of the button elements, on the remote control 1 positioned in the user's fingers. For the sake of clarity, not all the pressure take-up sides 34 of the individual button elements 5, 8 to 12 and 14 to 19 are given reference signs in FIG. 2.

The component of the pressure exerted by the user on the pressure take-up sides 34 of the button elements 5, 8 to 12 and 14 to 19 which points in the pressure direction 20 is now transmitted to a pressure take-up side 35 of the pressure take-up element 30 assigned to the respective button element 5, 8 to 12 and 14 to 19. Through this component of the pressure, the above-mentioned corresponding contact dome 24 is pressed down and the switching contacts are short-circuited.

A second component of the pressure exerted by the user on the pressure take-up sides 34 of the button elements 5, 8 to 12 and 14 to 19, which points at right angles to the pressure direction 20, pushes the respectively pressed button element 5, 8 to 12 and 14 to 19 to the side, and tilts the corresponding pressure take-up element 30. This can cause the button elements 5, 8 to 12 and 14 to 19 to tilt in the remote control 1. The likelihood of such tilting increases with the height 36 of the pressure take-up elements 30. For the sake of clarity, not all these heights 36 are given their own reference signs in FIG. 2. However, the pressure take-up elements 30 and their heights 36 cannot be made arbitrarily small in remote controls for multimedia devices. On account of their grip properties, these types of remote controls must be designed such that they are somewhat rounded in their body, which requires a large distance between the lower shell 3 and the upper shell 2. The pressure take-up elements 30 between the printed circuit board 21 in the lower shell 3 and the button elements 5, 8 to 12 and 14 to 19 on the upper shell 2 must bridge this large distance.

The user is thus required to have a certain amount of skill to be able to press the buttons precisely in the pressure direction 20. For users with motor impairments for whom this level of skill cannot be expected, such as older users, suitable guides for the button elements 5, 8 to 12 and 14 to 19 can usually absorb these tilting forces and prevent tipping.

However, it may be necessary for design or technical reasons to arrange some of the button elements 5, 8 to 12 and 14 to 19 close together with a very small spacing such that a suitable guide cannot be inserted. This is the case for the remote control shown in FIG. 1, with the button elements 14 to 19 of the button ring 13 and the button elements 8 to 12 inside the button ring 13. In order to further explain the exemplary embodiment, the button elements 14 to 19 of the button ring 13 are examined below. However, this should not be understood as a restriction, as the embodiments can be transferred to any button element in the remote control 1 which is to be positioned so close to another button element that a guide for avoiding tilting cannot be inserted, as for example the confirmation button 12.

The button elements 14 to 19 of the button ring 13 form a circle around the circular control ring 9.

Here, the first button element 14 and the fourth button element 17 of the button ring 13, as well as the third button element 16 and the sixth button element 19 of the button ring 19, are embodied in each case as a single piece in the form of a rocker button. Every rocker button has supporting pins 34, into which the lower shell 3 can be pressed. If a button element 14, 16, 17, 19 of a rocker button is pressed in the pressure direction 20, the supporting feet 34 prevent the other button element 14, 16, 17, 19 on the rocker button from also being pressed down at the same time.

Between the rocker buttons and thus the button elements 14, 16, 17 and 19, the second and fifth button elements 15, 18 are positioned in the button ring 13 very close together with respective gaps 37 of less than 1 mm. For the sake of clarity, not all these gaps 37 are given reference signs in FIG. 2. Since the second and fifth button elements 15, 18 between the rocker buttons cannot or are not to be positioned with a guide owing to the small gaps 37, these two button elements 15, 18 could, in principle, tilt in the remote control if the user presses these button elements 15, 18 at an angle instead of precisely in the pressure direction 20.

Here, the films 31, 32 engage, absorb the pressure forces exerted by the user at an angle to the pressure direction 20, and thus ensure that pressure forces are only transmitted to the individual pressure take-up elements 30 in the pressure direction 20 when the second and fifth button elements 15, 18 are pressed. This effectively prevents tilting of the pressure take-up elements 30, regardless of their height 36.

However, should the pressure take-up elements 30 below the second and fifth button elements 15, 18 still tilt slightly despite the films 31, 32, an associated tipping with the rocker buttons in the button ring 13 can be avoided by way of a thickness 47 of the button elements 14 to 19 in the button ring 13 being tapered towards the individual gaps 37. Should the button elements 14 to 19 nonetheless tilt when pressed by the user, they can slide under the respective neighboring button elements 14 to 19 in the button ring 13 without abutting against them.

In order to hold the films 31, 32 in a predetermined position on the underside of the button elements 14 to 19 of the button ring 13 as viewed in the pressure direction 20, walls 45 can be formed on at least some of the button elements 14 to 19, with which walls the films 31, 32 can be held in a form-fitting manner as viewed at an angle to the pressure direction 20. Not all these walls 45 can be seen in the view in FIG. 2.

In the present embodiment, the first film, and therefore the flexible printed circuit board 31, has a capacitive sensor in order to enable the alternative input of data via swiping, i.e. the flexible printed circuit board 31 has a number of capacitor plates 38, which are separated from one another by way of zigzag-shaped dielectric gaps. For the sake of clarity, not all these capacitor plates 38 and dielectric gaps 39 are given reference signs in FIG. 2.

Reference is made to FIG. 3 showing a process diagram for reconditioning 48 the remote control 1.

The reconditioning 48 starts with a delivery 49 of the remote control 1 in a condition, in which the remote control 1 was used and, for example, was returned by an end user after purchasing. It can be provided, for example, in a container with a number of other remote controls.

After the delivery 49, the remote control 1 is subjected to a pre-test 50. This pre-test 50 serves, among other things, to test the technical function of the remote control 1. For this purpose, it may be tested whether the remote control 1 reacts with the expected control signals when the individual buttons on the upper shell 2 are pressed. If this is not the case, the remote control 1 is led to a decommissioning 51, in which it is either disposed of or otherwise recycled.

If the pre-test 50 shows, however, that the remote control 1 is functioning technically and also doesn't have any other apparent visual or technical flaws, the upper shell 2 and the lower shell 3 of the remote control 1 are removed in one disassembly step 52, so that only the technical elements as shown in FIG. 2 remain. The disassembly step 52 may be carried out in an automated manner by means of a machine tool. No further details, however, shall be provided here.

The button elements 14 to 19 of the button ring 13, as well as the control ring 9 and the adhesive films 28 beneath them, and the films 31, 32 are removed in an extraction step 53, because they are more of an obstacle for the further process of reconditioning 48, and may even adversely affect the result of the reconditioning 48. One part 54 of the remote control 2 comprising all of the elements between the keypad 4 and the printed circuit board 21 remains. This remaining part 54 of the remote control 1 is shown in FIG. 4.

After the extraction step 53, the remaining part 54 of the remote control 1 undergoes a disinfection and cleaning step 55 which will be described in more detail later by means of FIG. 5.

After the disinfection and cleaning step 55, the remaining part 54 of the remote control 1 undergoes an inspection step 56, in which particularly the printed circuit board 21 and the rubber mat 29 are examined for signs of damage. If the rubber mat 29 appears to be damaged, it is removed from the printed circuit board 57 in a sorting step 57, and led to the decommissioning 51.

The remaining part 54 of the remote control 1 is then assembled to a new remote control in an assembly step 58. The parts missing for it, such as the upper shell 2, the lower shell 3, the button elements 14 to 19 of the button ring 13, the control ring 9, the adhesive films 28 underneath, the films 31, 32, and possibly the rubber mat 29 are introduced in this assembly step 58 as new parts.

This assembly step 58 is followed by another test step 59, in which the thus reconditioned remote control 1 is tested for 100% functioning, and sorted out again if necessary.

If the remote control 1 proves to be 100% functional, it is then provided with a product identification, a guarantee label etc. in an identification step 60. It is then prepared for resale in a packaging step 61. The thus reconditioned remote control 1 may then, for example, be stored in a warehouse 62,

In the following, FIG. 5 is used to describe a disinfection device 63 as an example in which the disinfection and cleaning step 55 is carried out. The disinfection device 63, however, is purely an example. The disinfection and cleaning step 55 can be carried out in any way, including manually.

The disinfection device 63 comprises an operation side 64 and a processing side 65 which are separated from each other by a screen 66. A rotary plate 67 turns bearing surfaces 68 in a direction of rotation 69 between the sides 64, 65. For the sake of clarity, not all of the bearing surfaces 68 on the rotary plate 67 are given their own reference signs.

A worker, who is not shown in any further detail, puts the remaining parts 54 of the remote control 1 at the operation side 64 on the bearing surfaces 68 with the printed circuit board 21 facing downwards, so that the rubber mat 29 with the bearing surfaces 5 is facing upwards. The rotary plate 67 turns the remaining parts 54 of the remote control 1 in the direction of rotation 69 at the processing side 65.

At the processing side 65, the rubber mats 29 and the button elements 5 of the remaining parts 54 of the remote control 1 held thereon are blasted with four nozzles 70 from four different directions 71 with a bacterially disinfecting abrasive. The abrasive is supplied via tubes from a feeding device 72. However, for the sake of clarity, these tubes are not shown in FIG. 5.

In the present embodiment, the abrasive is carbon dioxide cooled down to dry ice. When the dry ice particles hit the rubber mats 29 and the button elements 5, they locally undercool and embrittle the surface. The dry ice particles coming after thus enter the brittle cracks being generated, and sublimate abruptly after they hit the surface. The dry ice becomes gaseous and increases its volume so much that, in addition to disinfection, it also blows dirt off the surface of the rubber mats 29 and the button elements 5. In this way, not only disinfection but also cleaning of the surface of the rubber mats 29 and the button elements 5 is achieved at the same time.

The blown off dirt particles may then be suctioned off with the sublimated dry ice particles by means of an extraction system 73.

The dry ice should have a temperature in the range of the sublimation point of carbon dioxide, which is at −78.9° C. The time of exposure of the individual rubber mats 29 and the button elements 5 thereon should be between 5 s and 7 s for each nozzle 70.

1. A method for reconditioning a remote control (1) with a housing comprising an upper shell (2) and a lower shell (3), the remote control (1) further comprising a printed circuit board (21) carrying raised buttons (5) for triggering control signals by pressure, the raised buttons (5) penetrating the upper shell (2), said method comprising:
removing (52) the upper shell (2) and the lower shell (3);
blasting (55) at least the raised buttons (5) on the printed circuit board (21) with an antibacterial abrasive, and
inserting (58) the printed circuit board (21) with the raised buttons (5) supported thereon between a new upper shell (2) and a new lower shell (3).

2. A method as claimed in claim 1, wherein the abrasive is dry ice.

3. A method as claimed in claim 2, wherein the dry ice is carbon dioxide.

4. A method as claimed in claim 3, wherein the carbon dioxide in the form of dry ice has a temperature between −80 C and −75 C.

5. A method as claimed in claim 1, wherein the raised buttons (5) are exposed to the abrasive from at least two different directions (71).

6. A method as claimed in claim 5, wherein a time of exposure from every direction (71) lies between 1 s and 10 s.

7. A method as claimed in claim 1, wherein the abrasive is suctioned off (73) after the blasting of the raised buttons (5).

8. A method as claimed in claim 1, comprising:
carrying out a function test (50) before removing the upper shell (2) and the lower shell (3).

9. A remote control (1) comprising a housing and a printed circuit board (21), the housing comprising an upper shell (2) and a lower shell (3), the printed circuit board (21) comprising raised buttons (5) for triggering control signals by pressure, the raised buttons (5) penetrating the upper shell (2), wherein the remote control has been reconditioned by a method comprising:
removing (52) the upper shell (2) and the lower shell (3);
blasting (55) at least the raised buttons (5) on the printed circuit board (21) with an antibacterial abrasive; and
inserting (58) the printed circuit board (21) with the raised buttons (5) supported thereon between a new upper shell (2) and a new lower shell (3).

10. A device (63) to be used when reconditioning a remote control (1), the remote control (1) comprising a housing and a printed circuit board (21), the housing comprising an upper shell (2) and a lower shell (3), the printed circuit board (21) comprising raised buttons (5) for triggering control signals by pressure, the raised buttons (5) penetrating the upper shell (2), wherein the remote control has been reconditioned by a method comprising removing (52) the upper shell (2) and the lower shell (3), blasting (55) at least the raised buttons (5) on the printed circuit board (21) with an antibacterial abrasive, and inserting (58) the printed circuit board (21) with the raised buttons (5) supported thereon between a new upper shell (2) and a new lower shell (3), the device (63) comprising
a loading station (64) for inserting the printed circuit board (21) with the raised buttons (5) supported thereon,
a blasting station (70) adjoining the loading station (64) for blasting the raised buttons (5) on the printed circuit board (21) with an antibacterial abrasive, and
an unloading station (64) adjoining the blasting station (70) for removing the printed circuit board (21) after blasting.

11. A method as claimed in claim 5, wherein a time of exposure from every direction (71) lies between 5 s and 7 s.
